(19) United States
(12) Patent Application Publication
(10) Pub. No.: US 2019/0124273 A1
(43) Pub. Date: Apr. 25, 2019

(54) ENVIRONMENTAL ACQUISITION SYSTEM FOR ACQUIRING A SURROUNDING ENVIRONMENT OF A VEHICLE, AND METHOD FOR ACQUIRING A SURROUNDING ENVIRONMENT OF A VEHICLE

(71) Applicant: Robert Bosch GmbH, Stuttgart (DE)

(72) Inventors: Peter Liebetraut, Gundelfingen (DE); Marc Geese, Ostfildern Kemnat (DE); Ulrich Seger, Leonberg-Warmbronn (DE)

(21) Appl. No.: 16/157,321

(22) Filed: Oct. 11, 2018

(30) Foreign Application Priority Data
Oct. 19, 2017 (DE) 102017218722.0

(51) Int. Cl. H04N 5/262; G06T 3/40; H04N 5/232; H04N 5/225; G02B 13/08

(52) U.S. Cl. CPC H04N 5/2621; G06T 3/40; G02B 5/10; H04N 5/2254; G02B 13/08; H04N 5/23229

(57) ABSTRACT

An environmental acquisition system for acquiring a surrounding environment of a vehicle includes a sensor with a light-sensitive sensor surface and an imaging device that is designed to produce a distorting image of the surrounding environment on the sensor surface, the image having at least two distortion zones each assigned to a different region of acquisition of the environmental acquisition system, in which zones the surrounding environment is imaged with respectively different imaging scales.

### CROSS-REFERENCE TO RELATED APPLICATIONS

The present application claims priority under 35 U.S.C. § 119 to DE 10 2017 218 722.0, filed in the Federal Republic of Germany on Oct. 19, 2017, the content of which is hereby incorporated by reference herein in its entirety.

### FIELD OF THE INVENTION

The present invention relates to image processing for producing an image of a vehicle environment.

### BACKGROUND

Machine image processing for environmental acquisition applications, camera systems, or optical systems that permit, as much as possible, an equidistant imaging corresponding to a gnomonic projection have proven particularly advantageous. In this projection, the image is angle-preserving. In particular for wide-angle lenses, other projections are also known.

### SUMMARY

Against this background, the approach presented here provides embodiments including an environmental acquisition system for acquiring a surrounding environment of a vehicle, a method for acquiring a surrounding environment of a vehicle using an environmental acquisition system, and a corresponding computer program.

The approach presented here is based on the recognition that an environmental acquisition system having an optical system for multimorphic imaging of the surrounding environment can be realized in which the surrounding environment is imaged with distortion. In this way, on one and the same sensor a plurality of regions can be produced having different imaging characteristics, enabling an improved ability to recognize objects in machine image processing devices.

Particular demands are placed on environmental acquisition systems for driver assistance functions or autonomously driving systems because, for the vehicle controlling, very different kinds of objects have to be registered, such as other traffic participants, the condition of the roadway, or optical information signs. In particular, these applications require in part different imaging scales in different directions of view.

Depending on the driving situation, interventions in the controlling of the vehicle are a function of different “perceptions.” An imaging of the surrounding environment, via a monomorphic imaging on a video sensor, that is adequate for all situations and applications places demands on the components that are difficult to meet.

Therefore, in order to enable a reliable acquisition of relevant objects, a plurality of cameras having specialized functional properties are sometimes used that differ for example by having different directions of view such as left, right, up, down, front, or rear, different acquisition angles, such as telephoto, standard, or wide-angle, different focus ranges, such as near focus or far focus, and that differ in their resolution, i.e., their sampling values or spectral acquisition regions.

In order to ensure the signal integrity, images from a plurality of sources have to be temporally and spatially correlated with one another. This can result in a high degree of complexity and cost outlay, in particular if signals from a plurality of physical acquisition units having different sampling time bases, tolerance-affected direction of view differences, and intrinsic and extrinsic calibration have to be matched with one another. Through the approach presented here, this complexity can be made more manageable. In this way, costs can be reduced.

For the image processing, in principle a gnomonic projection is preferred, but this type of projection optics has a greatly increasing image height for large angles of view. In order to properly handle the region of acquisition as it becomes larger and larger with sensor resolutions that increase only moderately, solutions can be found that were known already from cinema photography and projection techniques of the 20th century, and that enable anamorphic imaging with a deliberately symmetrically distorted optics. A sample application is the compression of scenes having high aspect ratios, such as 2.55:1, onto a 35 mm film. An anamorphic projection can also be used to image identical angles of view on an image plane with a particular aspect ratio.

In addition to this, optical systems having radially variable projection can be used for monitoring systems. In this way, monitored areas of high interest can be imaged on the image sensor in particularly detailed fashion (low isocline density), while angles of view that contribute less information can be imaged with compression (high isocline density).

Such projections are either radially symmetrical relative to the optical axis of the system or have at least one symmetry element, for example a mirror plane in the case of an elliptical projection. The various projections are realized through the use of a distorting optical system, i.e., the distortion of a lens is used as a design feature. In some applications, such as panorama photography or cinematography, this characteristic is deliberately used to achieve an efficient use of recording systems. Here, the desired distortion is caused through the use of aspherical elements such as prisms, toric lenses rotated by 90° relative to one another, or cylinder lenses. For radially symmetrical distortions, polished or pressed aspheric lenses can also be used.

Due to the relevant objects that are to be acquired, driver assistance systems can have an image field having a more or less strongly pronounced symmetrical distortion. For example, a good coverage of the area to be monitored can be achieved through the use of three image sensors and three optical systems. However, this occupies more space in the vehicle, and the power consumption and system costs are increased. For the processing of the images, a rectification can be carried out in order to calculate back to a perspective central projection and to facilitate the recognition of objects.

For applications in the area of driver assistance, greatly differing demands on the aperture angle, or the resolution, can be met through the use of parallel cameras or camera heads having different angular resolution and different sensors.

The approach presented here is essentially based on realizing the imaging characteristics of an optical path in a manner that can be freely realized and is not necessarily point-radial or mirror-symmetrical. By design, the properties can be adjusted statically by using provided adjusting devices, or can also be adjusted dynamically. Such an imaging can therefore be referred to as multimorphic, because local differences in the imaging scale have the result that the shape of an object appears different depending on the angle of observation.

This approach is based on the recognition that not all angles of view contribute the same information content for a driver assistance system. Through the deliberate distortion of the image field, a more uniform information density can be produced on an image sensor, for example in that viewed areas having a high information content occupy large areas of the image surface, and, conversely, unimportant viewed areas are compressed on the image surface. The distribution of the image distortion is not necessarily radially symmetrical or axially symmetrical. In the case of an axially symmetrical realization of the isoclines, a central region of acquisition can for example be imaged with a high degree of detail, i.e., with many pixels per degree and lower isocline density.

The area having the largest information content in the sense of automated image evaluation need not run symmetrical to the optical axis or to the sensor. In an optical system with multimorphic distortion, the region having the highest pixel density can also be displaced upward.

Imaging using an optical system that has zones that can be freely realized having different imaging scales is particularly resource-efficient, because the sensor surface is used particularly efficiently and the required post-processing benefits from the fact that a lower quantity of data is processed, because redundancies are reduced to a minimum.

Some advantages of the approach presented here are that the imaging of the surrounding environment can be realized zone by zone, corresponding to a local resolution requirement of the environmental acquisition system, without using a plurality of imaging systems or imaging units or sensor units, and that the assignment of acquired objects from various directions of view is provided by a single optical system that preferably images onto one sensor. In this way, after installation a particularly precise assignment is provided, because paths strongly affected by tolerances, for example a plurality of cameras or separate optical paths that are to be adjusted mechanically to one another, are avoided.

According to an example embodiment, an environmental acquisition system for acquiring a surrounding environment of a vehicle includes: a sensor having a light-sensitive sensor surface; and an imaging device that is designed to produce a distorting image of the surrounding environment on the sensor surface, the image having at least two distortion zones each assigned to a different region of acquisition of the environmental acquisition system, in which the surrounding environment is imaged with a respectively different imaging scale.

A sensor can be understood as an image sensor, for example a CMOS sensor or some other light-sensitive component. An imaging device can be understood as an optical device made up of one or more optical components such as mirrors or lenses. A region of acquisition can be understood as a sub-region of an object space to be acquired that is assigned to a particular angle of view of the environmental acquisition system. A distortion can be understood as an optical deformation in the sense of local changes of an imaging scale in a projection. An imaging scale can be understood as a ratio between an image size of an optical image of an object and its real size.

According to an example embodiment, the imaging device can be designed to change the distortion zones. In this way, the environmental acquisition system can operate as efficiently as possible. For this purpose, the imaging device can be designed to receive a suitable control signal for changing at least one of the distortion zones. Such a control signal can for example cause a change in the region of acquisition to which the distortion zone is assigned, and/or a change of the imaging scale of the distortion zone. The control signal can for example be received via an interface to an assistance system that uses images of the environmental acquisition system, or can be generated by the environmental acquisition system itself, for example using currently acquired images. The control signal can also be received via an interface for configuring the environmental acquisition system. In this way, the environmental acquisition system can for example be adapted to the characteristics of a vehicle on which the environmental acquisition system is or will be installed. The change signal can for example be an analog or digital electrical signal.

According to an example embodiment, the environmental acquisition system can have a control device that is designed to change the distortion zones by controlling the imaging device using an image signal provided by the sensor, as a function of a respective information content of the regions of acquisition. A control device can be understood as an electrical device that processes sensor signals and outputs control and/or data signals as a function thereof. The control device can have an interface that can be realized as hardware and/or as software. In the case of a realization as hardware, the interfaces can for example be part of a so-called system ASIC that contains a wide variety of functions of the control device. However, it is also possible for the interfaces to be separate integrated circuits, or to be made up at least in part of discrete components. In the case of a realization as software, the interfaces can be software modules present for example on a microcontroller alongside other software modules. Through this example embodiment, for example regions of acquisition having a low information content are compressed, and regions of acquisition having a large information content can be imaged in enlarged fashion. In this way, a particularly high efficiency can be achieved in the acquisition of the surrounding environment.

It is further advantageous if the imaging device is designed to produce the image having non-symmetrical distortion zones. A non-symmetrical distortion zone can be understood as a distortion zone that is neither radially nor axially symmetrical. In this way, a wide variety of scenes in the surrounding environment can be acquired efficiently and precisely.

According to a further example embodiment, the imaging device can have at least one optical element that is freely shaped and/or is situated on a windshield of the vehicle and/or is modifiable with regard to its optical properties, for producing the distortion zones. In this way, the imaging device can be integrated into the vehicle with a relatively low outlay.

Here, the optical element can be realized as a lens element and/or mirror element and/or hybrid element. A hybrid element can be understood as an optical element made up of different materials. For example, an optically functional structure can be attached on the hybrid element. Through this example embodiment, the environmental acquisition system can be provided at low cost.

It is also advantageous if the optical element has a microstructure for producing the distortion zones. A microstructure can be understood as a structure for the deliberate distortion of the image of the surrounding environment. In this way, the optical characteristics of the optical element can be changed deliberately with a relatively low additional outlay.

In addition, the approach presented here provides a method for acquiring a surrounding environment of the vehicle using an environmental acquisition system, the environmental acquisition system having a sensor having a light-sensitive sensor surface and an imaging device, the method including: producing a distorting image of the surrounding environment on the sensor surface using the imaging device, the image having at least two distortion zones, each assigned to a different region of acquisition of the environmental acquisition system, in which zones the environment is imaged with a respectively different imaging scale.

According to an example embodiment, the method includes a step of controlling the imaging device using an image signal provided by the sensor in order to modify the distortion zones as a function of a respective information content of the regions of acquisition.

This method can be implemented for example in software or hardware, or in a mixed form of software and hardware, for example in a control device.

Also advantageous is a computer program product or computer program having programming code that can be stored on a machine-readable carrier or storage medium such as a semiconductor memory, a hard drive, or an optical memory, and can be used to carry out, implement, and/or control the steps of the method according to one of the example embodiments described above, in particular when the program product or program is run on a computer or device.

Example embodiments of the present invention are shown in the drawings and are explained in more detail in the following description.

### BRIEF DESCRIPTION OF THE DRAWINGS

FIG. 1 shows a schematic representation of an environmental acquisition system according to an example embodiment.

FIG. 2 shows a schematic representation of an environmental acquisition system according to an example embodiment.

FIG. 3 shows a schematic representation of an environmental acquisition system according to an example embodiment.

FIG. 4 shows a schematic representation of an environmental acquisition system according to an example embodiment.

FIG. 5 shows a schematic representation of an imaging device according to an example embodiment.

FIG. 6 shows a top view of a lens element from FIG. 5 according to an example embodiment.

FIG. 7 shows a top view of a lens element from FIG. 5 according to an example embodiment.

FIG. 8 shows a top view of a sensor according to an example embodiment.

FIG. 9 shows a cross-sectional representation of a sensor from FIG. 8 according to an example embodiment.

FIG. 10 shows a view from below of a sensor from FIG. 8 according to an example embodiment.

FIG. 11 shows a cross-sectional representation of a sensor 102 according to an example embodiment.

FIG. 12 shows a schematic representation of an image provided by a sensor according to an example embodiment.

FIG. 13 shows a schematic representation of a distribution of distortion zones of an imaging device according to an example embodiment.

FIG. 14 shows a schematic representation of a multimorphic symmetrical image produced by an imaging device according to an example embodiment.

FIG. 15 shows a schematic representation of a multimorphic symmetrical image produced by an imaging device according to an example embodiment.

FIG. 16 shows a schematic representation of a multimorphic non-symmetrical image produced by an imaging device according to an example embodiment.

FIG. 17 is a flowchart of a method according to an example embodiment.

FIG. 18 shows a schematic representation of a control device according to an example embodiment.

FIG. 19 shows a schematic representation of a system architecture of an environmental acquisition system according to an example embodiment.

FIG. 20 shows an example of a highly distorting projection of a scene into an image plane using an imaging device according to an example embodiment.

### DETAILED DESCRIPTION

In the following description of advantageous example embodiments of the present invention, identical or similar reference characters are used for elements shown in the various Figures and having similar function, and repeated description of these elements is omitted.

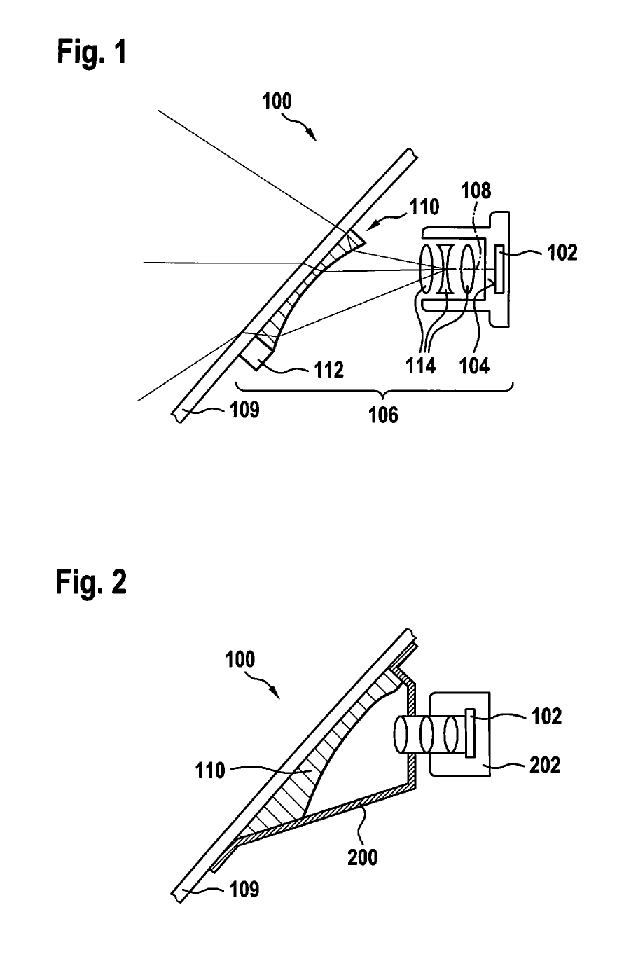

FIG. 1 shows a schematic representation of an environmental acquisition system 100 according to an example embodiment. Environmental acquisition system 100 for acquiring a surrounding environment of a vehicle includes a sensor 102 having a light-sensitive sensor surface 104 onto which a distorting image of the surrounding environment can be projected by an imaging device 106. Imaging device 106 is designed to produce the image in such a way that it has at least two distortion zones in which the surrounding environment is imaged with a respectively different imaging scale. For example, in this way, in one and the same image, regions of acquisition of the surrounding environment are shown in compressed fashion and other regions of acquisition of the surrounding environment are shown in enlarged fashion. Depending on the example embodiment, the distortion zones can have different sizes, can overlap one another, can be delimited from one another, or can transition continuously into one another. The distortion zones can be distributed symmetrically or non-symmetrically relative to an optical axis 108 of sensor 106.

According to this example embodiment, imaging device 106 has a plurality of optical elements, here for example a field lens element 110 attached on a windshield 109 of the vehicle, and a hybrid or freely-shaped element 112, also borne on the windshield, having a distorting effect and adjoining an edge of field lens element 110. In addition, imaging device 106 includes an imaging optical system, situated in a beam path between field lens element 110 and sensor 102, made up of three lens elements 114 configured one after the other. The beam path is indicated by three continuous lines.

FIG. 2 shows a schematic representation of an environmental acquisition system 100 according to an example embodiment. Differing from FIG. 1, environmental acquisition system 100 here includes a windshield-borne camera mount 200 for holding a camera 202 comprising sensor 102. Field lens element 110 is integrated into camera mount 200 as a freely-shaped element, and is thus a component of camera mount 200.

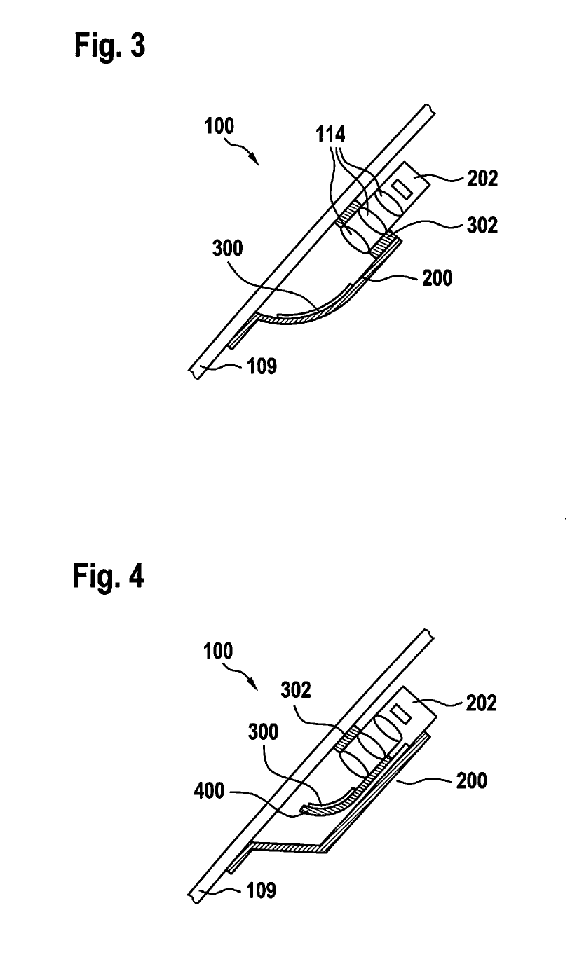

FIG. 3 shows a schematic representation of an environmental acquisition system 100 according to an example embodiment. Shown is camera mount 200 of FIG. 2. According to this example embodiment, camera mount 200 has a curved mirror element 300 for deflecting light beams passing through windshield 109 onto lens elements 114 of the imaging optics situated before camera 202. Mirror element 300 is also part of the imaging device of environmental acquisition system 100. For example, mirror element 300 is attached on an inner wall of camera mount 300. Lens elements 114 are held by a lens mount 302 fastened on camera mount 200. Mirror element 300 is also part of the imaging device of environmental acquisition system 100. For example, mirror element 300 is attached on an inner wall of camera mount 300. Lens elements 114 are held by a lens mount 302 fastened on camera mount 200.

FIG. 4 shows a schematic representation of an environmental acquisition system 100 according to an example embodiment. Environmental acquisition system 100 corresponds substantially to the environmental acquisition system described above on the basis of FIG. 3, with the difference that mirror element 300 here is not attached on the inner wall of camera mount 200, but rather is situated at a distance from the inner wall, as a reflective surface, on a mirror mount 400. Mirror mount 400 is formed as part of lens mount 302 according to this example embodiment.

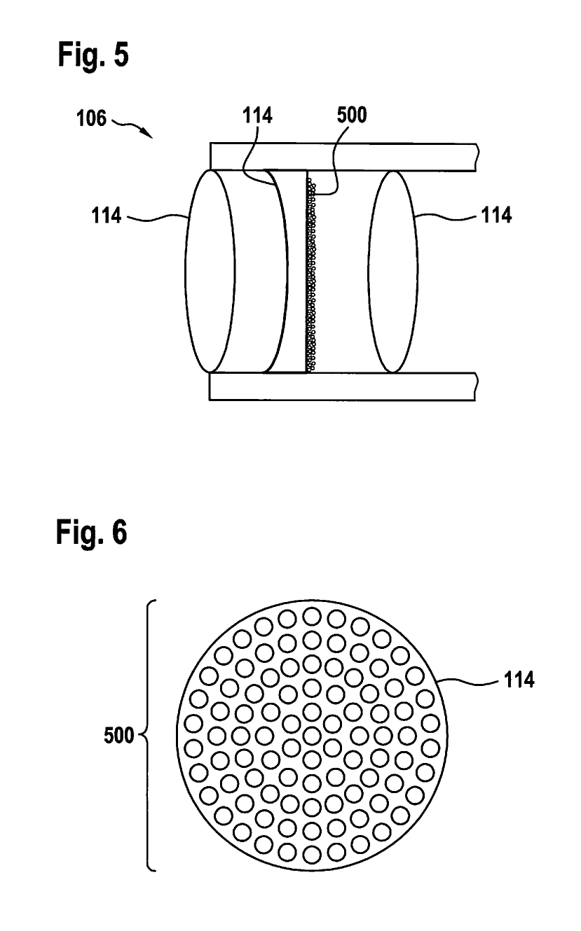

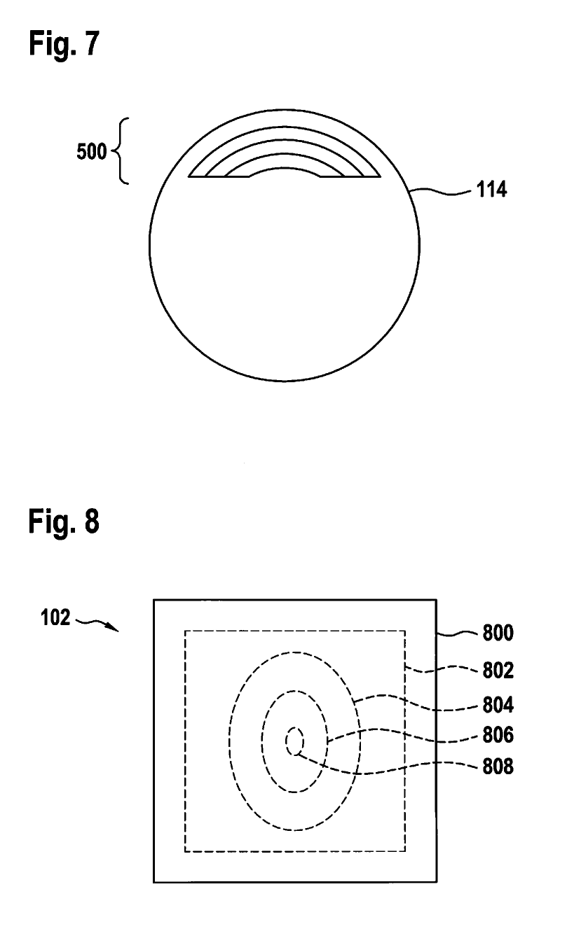

FIG. 5 shows a schematic representation of an imaging device 106 according to an example embodiment. Shown is the imaging optical system with the three lens elements 114 as described above on the basis of FIGS. 1-4. According to this example embodiment, a microstructure 500 is attached on a central one of the three lens elements 114, the microstructure being designed to cause a distortion of the image of the surrounding environment. Lens elements 114 are for example plastic lenses. Depending on the example embodiment, microstructure 500 is attached to an overall pass-through surface, or also only on parts of the pass-through surface, as can be seen from FIGS. 6 and 7.

FIGS. 6 and 7 each show a top view of center lens element 114 with microstructure 500 from FIG. 5.

FIG. 8 shows a top view of a sensor 102 according to an example embodiment. According to this example embodiment, sensor 102 is realized as a chip connected to a field lens 800, field lens 800 being a component of the imaging device of the environmental acquisition system. In the top view, as an example four distortion zones 802, 804, 806, 808 of field lens 800, marked by dashed lines, can be seen, by which the surrounding environment is imaged onto sensor surface of sensor 102 with a respectively different imaging scale.

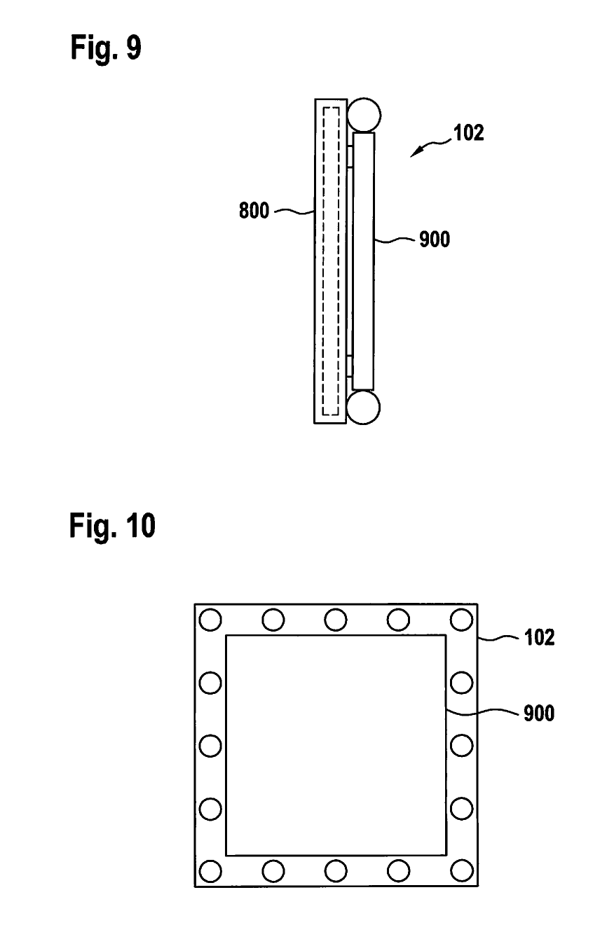

FIG. 9 shows a cross-sectional representation of a sensor 102 from FIG. 8. Shown are a sensor chip 900 and field lens 800 in the form of a layer having an optical effect applied on sensor chip 900. The optical effect is achieved for example through spherical or aspherical shaping or free shaping of field lens 800; variation in the index of refraction is achieved by a doped material or by a microstructuring of the surface.

According to an example embodiment, the optical effect is modifiable, and thus adjustable, using a control signal.

FIG. 10 shows a view from below of a sensor 102 from FIG. 8. Sensor 102 is realized for example as a CSP package having a shaped glass or plastic lid.

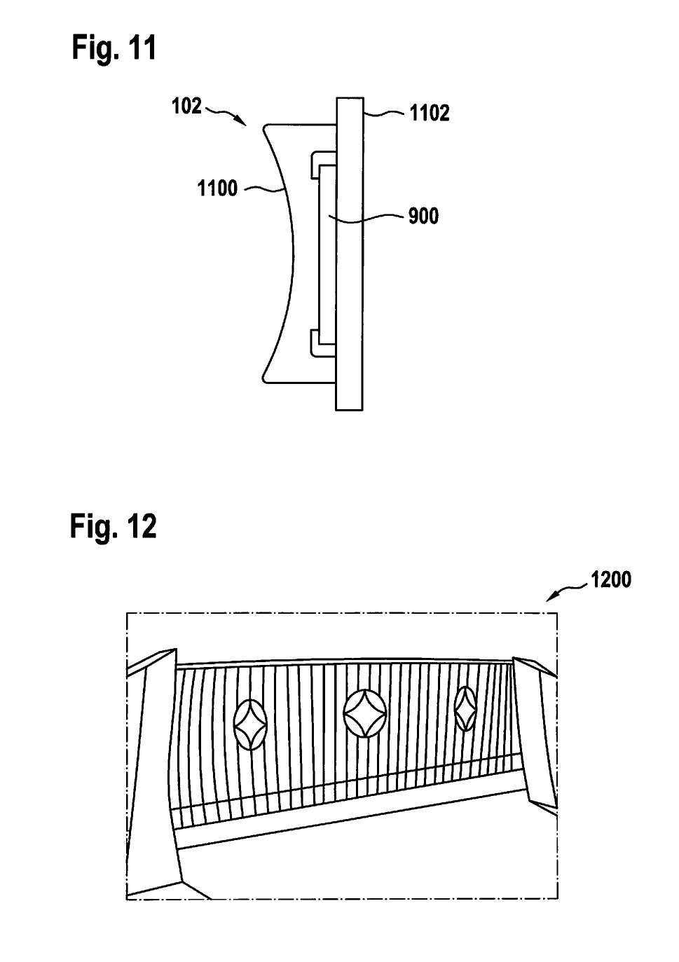

FIG. 11 shows a cross-sectional representation of a sensor 102 according to an example embodiment. Differing from FIGS. 8 through 10, here a transparent glob top material 1100 is placed onto sensor chip 900 in order to distort the image. Glob top material 1100 and sensor chip 900 are each connected to a bearer substrate 1102.

FIG. 12 shows a schematic representation of an image 1200, provided by a sensor according to an example embodiment. Shown as an example is a distorting image of an entry gate via a mirror belonging to the imaging device, having the shape of a slanted rectangular pyramid. The distortion of image 1200 makes it possible for example to image details of a grid of the entry gate in an enlarged fashion, and to image objects in the upper edge of the image with reduced size.

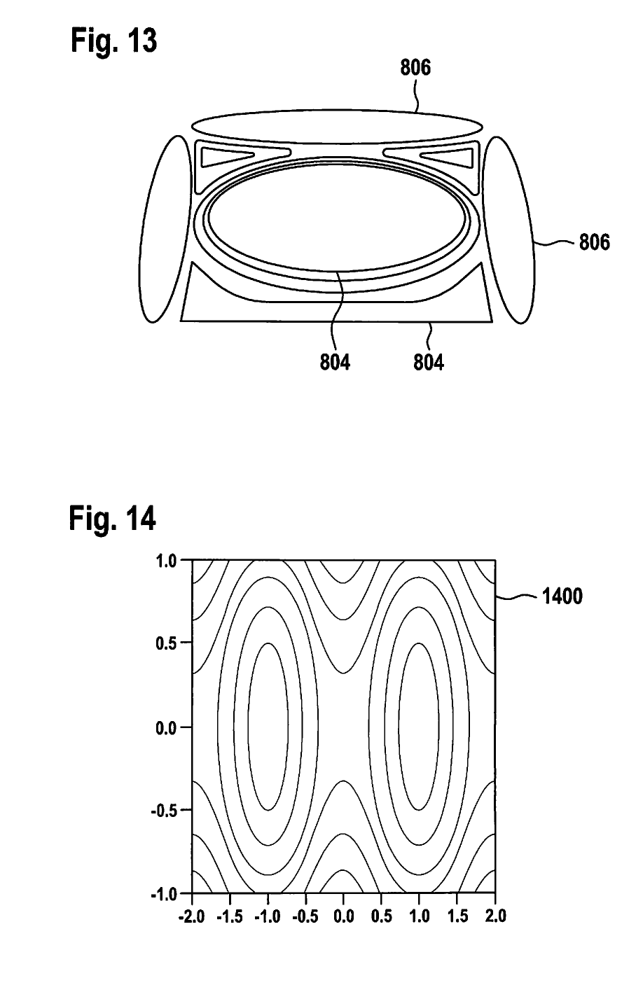

FIG. 13 shows a schematic representation of a distribution of distortion zones 802, 804, 806, 808 of an imaging device according to an example embodiment. The distribution zones are each marked with a line. For reasons of clarity, in FIG. 13 only four of the distribution zones are marked with reference characters.

FIG. 14 shows a schematic representation of a multimorphic symmetrical image 1400, produced by an imaging device according to an example embodiment.

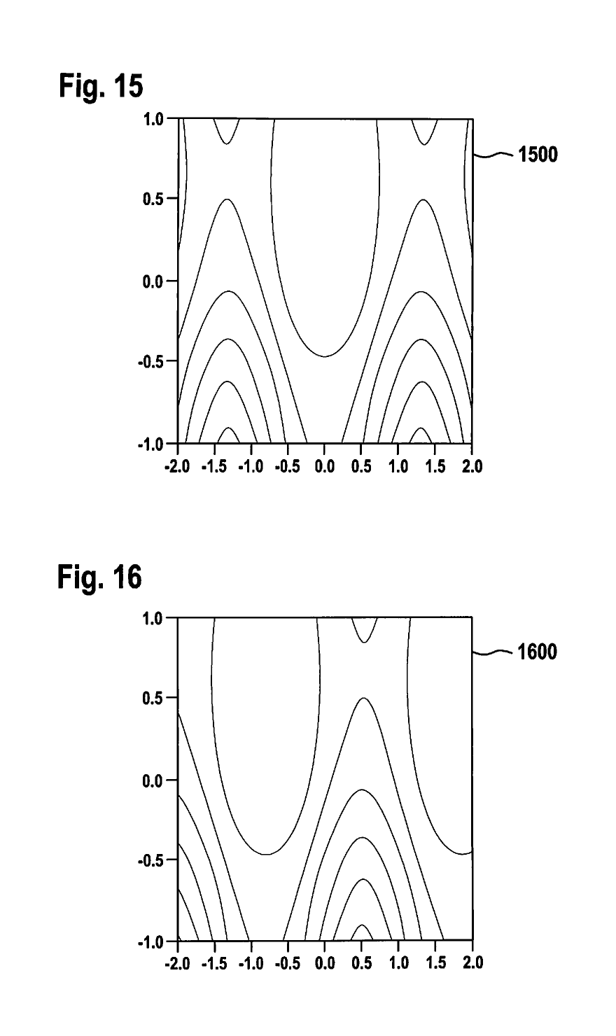

FIG. 15 shows a schematic representation of a multimorphic symmetrical image 1500, produced by an imaging device according to an example embodiment.

FIG. 16 shows a schematic representation of a multimorphic symmetrical image 1600, produced by an imaging device according to an example embodiment.

The distribution zones are indicated in FIGS. 14-16 by a multiplicity of isoclines that indicate the position of identical view angles in the image plane on the sensor surface. Denser line groups correspond to a larger angle of view region.

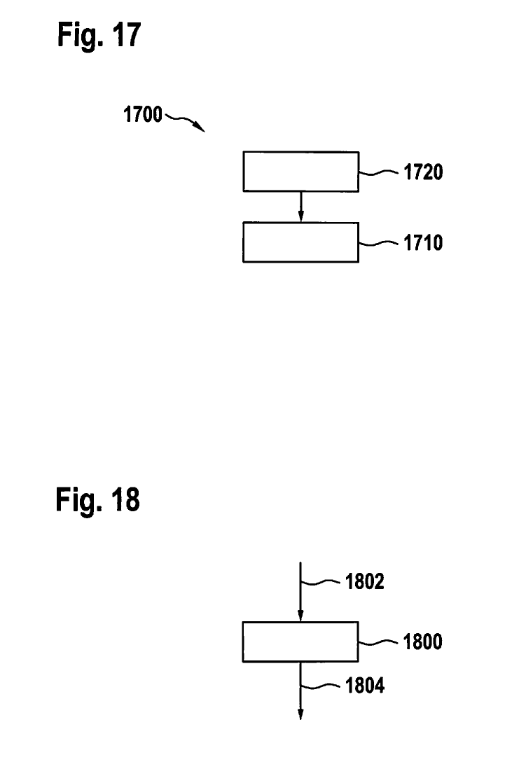

FIG. 17 is a flowchart of a method 1700 according to an example embodiment. Method 1700 for acquiring a surrounding environment of a vehicle can for example be realized by an environmental acquisition system as described above on the basis of FIGS. 1-16. Here, in a step 1710 a distorting image of the surrounding environment is produced on the sensor surface by the imaging device. In an optional step 1720, which for example precedes step 1710, the imaging device is controlled using an image signal provided by the sensor in order to modify the distortion zones as a function of a respective information content of the regions of acquisition of the environmental acquisition system. In this case, the image signal can be realized as a control signal, or, using the image signal, for example based on an image evaluation, a control signal can be produced that is suitable for causing the modification of the distorting zones through a suitable controlling of the imaging device. Alternatively, step 1720 is carried out in parallel with step 1710 or after step 1710.

FIG. 18 shows a schematic representation of a control device 1800 according to an example embodiment. Control device 1800 is designed to provide a control signal 1804 for controlling the imaging device, using an image signal 1802 of the sensor of the environmental acquisition system. Through the controlling of the imaging device, for example a shape or distribution of the distortion zones of the imaging device can be adapted to an information content of various image regions of an image represented by image signal 1802.

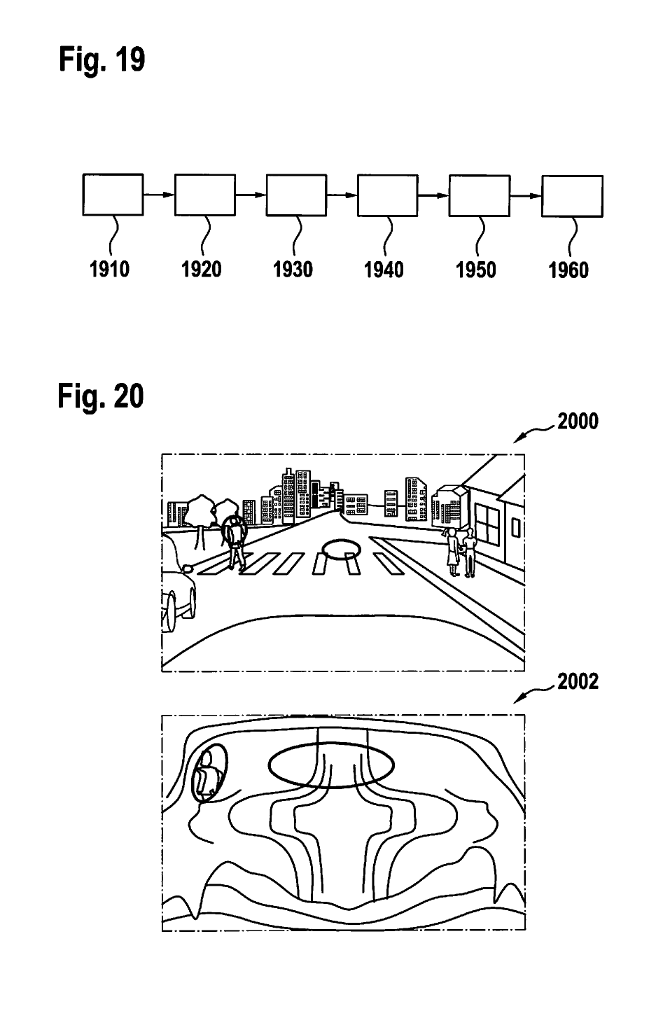

FIG. 19 shows a schematic representation of a system architecture of an environmental acquisition system according to an example embodiment. Here, a first block 1910 represents an object space, a second black 1920 represents an entry window of the environmental acquisition system, for example a windshield having a hybrid element, a third block 1930 represents a first imaging element, such as a freely shaped mirror or prism, a fourth block 1940 represents a second imaging element, for example lens elements, a fifth block 1950 represents a sensor-bound field lens, and a sixth block 1960 represents the sensor of the environmental acquisition system.

FIG. 20 shows an example of a strongly distorting projection of a scene 2000 into an image plane using an imaging device according to an example embodiment. At left scene 2000 is shown, and at right an image 2002 of scene 2000 is shown, provided by the sensor of the environmental acquisition device.

In the following, various example embodiments of the approach presented here are described again in other words.

Example embodiments of the present invention provide a system configured for the acquisition of the surrounding environment of an automated or partly automated driving vehicle, or of a vehicle having active or passive safety or comfort devices.

The environmental acquisition system can be vehicle-bound, or the recognition work can be performed by an external infrastructure, such as drones or portable or stationary devices connected to one another via a local data transmission network. The environmental acquisition system can also provide data for controlling vehicles. For example, at least one freely-shaped optical element is integrated into a beam path of the environmental acquisition system, the element being shaped to produce local image-field-dependent variations in the image.

Particularly advantageously, the variation of the imaging ratio is realized in a way that makes it possible to realize a resolution that is adapted to the task of recognition in various directions of view. The already-mentioned control signal can be used for this purpose.

Thus, for particular tasks, it can be appropriate to achieve a high degree of compression or stretching of a scene on the sensor, as is shown in FIG. 20. This distortion can be optimized in order to facilitate particular recognition tasks even if this can no longer be grasped as an image by a human observer. The strongly distorted image 2002 in FIG. 20 shows, for example, particular regions required for particular recognition tasks as being very rich in detail. Through an inverse transformation of parts or of the entire image, image 2002 can for example be transformed back into a rectified image that permits a particularly high resolution of objects at the emphasized locations.

For machine recognition tasks, in particular given the use of classification methods or learning networks, an image distorted in this way can also be used directly, without back-transformation, and can be used in a downstream image processing system for a resource-conserving recognition, because the image information has been optically redistributed in such a way that the maximum recognition performance is enabled with the smallest possible number of sampling points.

The environmental acquisition system is made up of one or more optically effective elements that, individually or together, enable the imaging named above. The use of one or more optical boundary surfaces having a freely shaped surface is particularly efficient.

This enables the production of distortion fields that have symmetries or that are free of symmetries, i.e., also distortions that are not radially symmetric or point-symmetric. In this way, an adaptation of the position of the isomorphic regions in the image field and of the local imaging scale to various applications or situations is enabled. Depending on the example embodiment, the environmental acquisition system is made up of all or some of the following components: a) windshield, rock-catcher plate, camera entry window or transparent protective dome; b) hybrid optical elements on the elements named under a); c) freely shaped, spherical, or aspherical mirrors; d) hybrid optical elements made up of one or more mirrors; e) spherical or aspherical lenses; f) hybrid optical structures on the aspherical lenses; g) freely shaped, spherical, or aspherical field lenses, for example in the form of a sensor package window or a sensor chip protective layer, such as a glob top made of LSR; and h) hybrid optical, in particular microstructured, layers on the sensor chip protective layer or sensor surface.

A particularly effective realization of the idea of the present invention is a freely shaped deflecting mirror in the optical path of the environmental acquisition system, for example making it possible to image objects from various directions. This element can particularly effectively be placed directly after the entry window, as can also be seen in FIG. 19. However, it is also possible to exchange the position of the elements, for example to swap the first and second imaging element from the system image.

The approach presented here is suitable for example for realizing an environmental acquisition system having various projection or imaging properties, combining various functions in one application, for example by providing: a) a zone for the acquisition of a highly resolved central region of approximately +/−30°; b) a zone for the acquisition of a highly resolved region, for example 50° to the left and to the right, for the recognition of crossing traffic; c) zones for lower-resolution acquisition of the peripheral environment; d) zones in which a piece of the windshield surface is projected onto the sensor, for example in order to carry out an icing analysis or to acquire the presence of raindrops or contamination; and e) imaging of an integral value of the external lighting.

The optical system is distorting in itself, be it through the contribution of a lens or through other unavoidable elements such as the windshield, or additional deliberately added elements. Through a skilled balancing of the overall design, it can be achieved that the processing requires less transmission bandwidth, less memory, less sensor surface, and less structural outlay and space requirement. In addition, in this way costs can be reduced.

The distortion of the image can be adapted to the requirements of algorithms of machine vision. The distortion can be regarded as divided into zones. The transition between different distortions can take place discretely, for example via a prism or a folded flat mirror, or continuously, for example via freely shaped mirrors or aspherical or toric lenses, or can be matched adaptively to the situation, for example using a zoom lens.

For the shaping of the distortion, for example the following elements are used: a) mirrors (spherical, parabolic, ellipsoid, freely shaped mirrors, for example NURBS) as continuous mirror surfaces or having points of discontinuity (two or more mirror segments that can be inclined to one another); b) prisms, where one or more surfaces of the prism can additionally be equipped with lenses or hybrid structures; c) aspherical lenses, toric lenses, also cylinder lenses, zonal (multi-focus) lenses, having different imaging scales; d) hybrid structures attached to one or more optical elements at one or both sides; e) adaptive optical elements such as adaptive mirrors (SLM, reflective membranes or foils), LCoS, adaptive lenses (liquid lenses, membrane lenses, elastomer lenses, LC lenses, and/or glass membrane lenses); and/or f) combinations of the optical elements named above.

The individual structural elements are for example mirrors, glasses, crystals, plastic, or metal. The reflective properties are achieved for example through metallic coating or thin-film coating (Bragg filters).

The mirrors are for example designed to achieve a desired advantageous distortion of the image, to correct aberrations and distortion contributions of the other components in the optical path, such as the distorting portion of the windshield, to act as transmission windows for infrared radiation, so that the sensor and the other components of the camera are not exposed to the sun's thermal radiation, or to realize other functions as the imaging of the surrounding environment. Specialized regions of the mirror are not directly involved in the imaging of the surrounding environment, and can be used for other acquisition tasks. For example, zones of the mirror can be shaped in such a way that they image parts of the windshield directly onto a particular region of the sensor. This region can for example act as a rain sensor. If the mirror is realized as a prism, the surfaces of the prism can optionally be provided with additional functions.

Lenses are for example made of glass, crystals, or plastics, such as thermoplastics, duromers, or elastomers.

Adaptive optical elements are for example refractive membrane lenses or liquid lenses. Optical properties of such optical elements can for example be adjusted using a control signal. In a membrane lens, a liquid is separated from its surrounding environment by a membrane. The liquid in the membrane can be absorptive in particular spectral regions in order to achieve a filtering function. In a liquid lens, a liquid is surrounded by another liquid, a gas, or a vacuum. Mirrors are for example membrane mirrors having a thin elastic membrane having reflective properties. Here, the realization can be such that incident light passes through the liquid before the reflection, or is reflected directly by the mirroring surface. Foil mirrors having thin, for example metallic, foil are shaped indirectly or by individual actuators. Further examples of mirrors are deformable solid-body mirrors having actuatable segments or liquid mirrors, for example on the basis of metallic liquids or a total reflection at liquid lenses. Likewise, a combination of a plurality of adaptive elements is possible, for example an achromatic lens made up of three membrane lenses, i.e., adaptive optical elements situated tightly next to one another, or an optical zoom system made up of a plurality of adaptive optical elements that can be purely reflective, purely refractive, or a combination of the two, i.e., catadioptric.

Hybrid optical elements are for example lenses or mirrors made of glass, plastics, also elastomers, crystals, or metal, attached to the functional structures. The hybrid structures are also made of these materials. The functional structures can have one or more layers, can be apertures or windows attached on the optical elements, such as orifices for suppressing scattered light, or can act diffractively, as meshes, or refractively, as lenses. The diffractive elements can act in amplitude-modulating or phase-modulating fashion. The hybrid refractive elements can be shaped as desired, for example as spherical surfaces, Fresnel structures, aspherical surfaces, or freely shaped surfaces. The entry window of the camera, for example a windshield, a headlight, or a camera dome, can also be realized as a hybrid element.

In the case of fixed elements, the distortion of the field of view is realized for example with one or more mirrors. Through the use of a mirror, the complexity of the lens can be reduced, the camera system can be better athermalized, and the catadioptric lens can be given additional functionality, for example that of an infrared bandpass.

The distortion of the field of view can in addition be realized with one or more aspherical or toric lenses, tilted and/or decentered spherical lenses or prisms.

Through the use of a mirror or deflecting prism, the exit window can be made smaller, even in the case of large angles of view, and the constructive volume can be reduced.

Specifically for entry windows, which are a constructive element, such as the windshield, headlight housing, or camera dome, the hybrid structure is for example realized such that the intrinsic aberrations of this component, such as the distortion of the windshield, are completely or partly corrected. For example, the hybrid element is designed to level out type variations or manufacturing tolerances of the component. In this way, variations of the distortion can be compensated by different variants of the component (for example siloxane on the windshield). Alternatively, the hybrid structure is realized such that it causes an additional desired aberration, such as an additional distortion at the edge of the field of view.

For example, in an example embodiment, the entry window of the sensor is also realized as a hybrid element simultaneously acting as a field lens. Given the combination of a field lens with a microlens array on the sensor, the freely selectable shape of the field lens enables an additional degree of freedom in the design of the optical system. The element can be made of a casting compound, for example siloxane. In addition to the macroscopic structure (sphere, asphere, freely shaped surface), microstructures can be shaped into the siloxane, such as moth-eye structures in order to produce a broadband anti-reflective layer, or prismatic or diffractive structures in order to produce an optical anti-aliasing filter. The siloxane can also be shaped such that the microlens structure of the sensor is superfluous. If this element is realized as a casting compound, then in addition to the optical properties there also result advantageous mechanical properties. For example, contaminations that can occur during manufacture no longer directly reach the sensor surface. As a result, the failure rate is reduced. The coefficient of thermal conductivity of the material is higher than that of air, so that heat of the sensor is distributed more uniformly and temperature peaks are avoided. If the casting compound is a siloxane, then the electronic component, i.e., the sensor and leads, is additionally protected.

Adaptive optical elements are used for example to compensate a temperature drift of the focal point, for example for refocusing or adaptive athermalization. This function is for example realized by an individual lens or lens group that can be displaced along the optical axis, a refractive adaptive optical element, or an adaptive reflective optical element. A plurality of adaptive optical elements can also be combined to form a zoom optical system. In this way, the region of acquisition of the camera can be adapted to the situation (large range at high speeds, wide-angle at low speeds). The situation-dependent distortion of the field of view is realized for example by an adaptive mirror.

The environmental acquisition system with an optical imaging device combines a plurality of different imaging properties simultaneously, e.g., in video real time. Depending on the embodiment, the environmental acquisition system contains at least one element that enables a non-radially symmetrical or point-symmetrical image of the surrounding environment, or at least one variably adjustable element for situational adaptation. In addition, the environmental acquisition system has for example an optical element connected to the windshield that has a distortion that is spherical or aspherical or contains a freely shaped surface that has a distortion field, as shown in FIG. 1. Alternatively, the environmental acquisition system has a field lens connected to a camera mount that has at least one spherical or aspherical surface or freely shaped surface and produces a distortion field, as shown in FIG. 2. Alternatively, the environmental acquisition system has a mirror connected to the camera mount that has a spherical or aspherical surface or freely shaped surface and produces a distorting field as shown in FIG. 3. The camera mount is realized for example as a mounting plate.

According to a further example embodiment, the environmental acquisition system has a mirror element integrated into a lens mount or a camera housing, having a spherical or aspherical surface or freely shaped surface and producing a distortion field, as shown in FIG. 4.

Optionally, the environmental acquisition system includes at least one lens that produces a microstructure for producing a spatially distributed distortion field, as shown in FIG. 5.

According to a further example embodiment, the environmental acquisition system includes at least one field lens connected to a sensor packaging and having a spherical or aspherical surface or freely shaped surface that produces a spatially distributed distortion field, as shown in FIGS. 8-10.

According to a further example embodiment, the environmental acquisition system includes a transparent sensor chip encapsulation that acts as a field lens and contains a spherical or aspherical surface or freely shaped surface or is provided with a microstructure that produces a spatially distributed distortion field, as shown in FIG. 11.

Also conceivable are combinations of a plurality of the elements named above to form a suitable optical system.

If an example embodiment contains an “and/or” linkage between a first feature and a second feature, this is to be read as meaning that according to an example embodiment the example embodiment has both the first feature and the second feature, and according to another example embodiment the embodiment has either only the first feature or only the second feature.

What is claimed is:

1. An environmental acquisition system for acquiring a surrounding environment of a vehicle, the environmental acquisition system comprising:
a sensor that includes a light-sensitive sensor surface; and
an imaging device configured to produce on the sensor surface an image of the surrounding environment with at least two distortion zones that are each assigned to a different respective region of acquisition of the environmental acquisition system and in each of which the surrounding environment is imaged with a respectively different imaging scale.

2. The environmental acquisition system of claim 1, wherein the imaging device is configured to modify the distortion zones.

3. The environmental acquisition system of claim 2, further comprising a control device configured to, based on respective information content of the regions of acquisition, control the imaging device to modify the distortion zones using an image signal provided by the sensor.

4. The environmental acquisition system of claim 1, wherein the imaging device is configured to produce the image such that the distortion zones are non-symmetrical.

5. The environmental acquisition system a of claim 1, wherein the imaging device includes at least one optical element for producing the distortion zones that is situated on a windshield of the vehicle.

6. The environmental acquisition system of claim 5, wherein the optical element includes at least one of the following three elements: a lens, a mirror, and an element formed of a plurality of materials.

7. The environmental acquisition system of claim 5, wherein the optical element includes a microstructure for producing the distortion zones.

8. The environmental acquisition system a of claim 1, wherein the imaging device includes at least one optical element that is modifiable with regard to its optical properties for producing the distortion zones.

9. A method for acquiring a surrounding environment of a vehicle using an environmental acquisition system, the environmental acquisition system comprising a sensor that includes a light-sensitive sensor surface and an imaging device, the method comprising:
producing on the sensor surface an image of the surrounding environment with at least two distortion zones that are each assigned to a different respective region of acquisition of the environmental acquisition system and in each of which the surrounding environment is imaged with a respectively different imaging scale.

10. The method of claim 8, further comprising, based on respective information content of the regions of acquisition, controlling the imaging device to modify the distortion zones using an image signal provided by the sensor.

11. A non-transitory computer-readable medium on which are stored instructions that are executable by a processor and that, when executed by the processor, cause the processor to perform a method for acquiring a surrounding environment of a vehicle using an environmental acquisition system, the environmental acquisition system comprising a sensor that includes a light-sensitive sensor surface and an imaging device, the method comprising:
producing on the sensor surface an image of the surrounding environment with at least two distortion zones that are each assigned to a different respective region of acquisition of the environmental acquisition system and in each of which the surrounding environment is imaged with a respectively different imaging scale.
